(19) United States
(12) Patent Application Publication
(10) Pub. No.: US 2025/0379439 A1
(43) Pub. Date: Dec. 11, 2025

(54) GUIDE APPARATUS FOR GUIDING AT LEAST ONE CABLE PLACED IN A PROTECTIVE HOSE, INCLUDING A SENSOR DEVICE WITH AN ULTRASOUND TRANSMITTER, AND RETROFIT KIT AND METHOD FOR MONITORING MOVEMENT OF SUCH A PROTECTIVE HOSE

(71) Applicant: BizLink Industry Germany GmbH, Roth (DE)

(72) Inventors: Asraful KABIR, Hannover (DE); Wei LIN, Hannover (DE); Fatih OEZEL, Hannover (DE)

(21) Appl. No.: 19/308,510

(22) Filed: Aug. 25, 2025

Related U.S. Application Data
(63) Continuation of application No. PCT/EP2024/054916, filed on Feb. 27, 2024.

(30) Foreign Application Priority Data
Feb. 28, 2023 (DE) 10 2023 201 837.3
Nov. 24, 2023 (DE) 10 2023 211 749.5

(51) Int. Cl. H02G 11/00; B25J 9/16; B25J 19/00

(52) U.S. Cl. CPC H02G 11/00; B25J 9/1674; B25J 19/0025

(57) ABSTRACT

A guide device guiding at least one cable in a protective tube includes a guide unit having a static support and a fastening element securing the protective tube. A sensor device for detecting movement of the fastening element relative to the support has an ultrasound transmitter as a first sensor component for emitting a sensor signal and a reflector as a second sensor component opposite the transmitter in the longitudinal direction. A signal path is formed between the sensor components in the longitudinal direction. To make the sensor device inexpensive and reliable, a reflector surface for the sensor signal is laterally adjacent the signal path for reflecting at least part of the sensor signal on the reflector surface along the path from the transmitter to the second sensor component during operation. A retrofit kit for the guide apparatus and a method for monitoring movement of the hose, are provided.

### CROSS-REFERENCE TO RELATED APPLICATION

This application is a continuation, under 35 U.S.C. § 120, of copending International Patent Application PCT/EP2024/054916, filed Feb. 27, 2024, which designated the United States; this application also claims the priority, under 35 U.S.C. § 119, of German Patent Applications DE 10 2023 201 837.3, filed Feb. 28, 2023 and DE 10 2023 211 749.5, filed Nov. 24, 2023; the prior applications are herewith incorporated by reference in their entirety.

### FIELD AND BACKGROUND OF THE INVENTION

The invention relates to a guide apparatus for guiding at least one cable which is placed in a protective hose, as well as to a retrofit kit and to a method for monitoring the movement of such a protective hose.

The guide apparatus serves in particular to guide a so-called hose package in a multiaxis articulated-arm robot, in particular a multiaxis industrial robot. In the multiaxis industrial robots used currently, the front articulated arm, also referred to as a robot hand, conventionally receives a plurality of individual cables for supplying a tool disposed on the robot hand, for example a grinding tool. The cables are for example electrical supply cables, electrical control cables, data cables or media feeds for gases or liquids. Those cables are combined in a so-called hose package, and are usually guided while being placed loosely in a protective hose. Such a hose package is exposed to high loads on the one hand because of the relative movements of the articulated arms with respect to one another, and in particular also because of the often adverse ambient conditions (high temperatures, aggressive media, for instance weld spatter, etc.). The protective hose is especially exposed to a high stress. A so-called corrugated hose is frequently used as the protective hose.

In order to enable reliable guiding of the hose package, it is conventional to use a guide apparatus having a restoring mechanism, which is provided so that a compensating movement of the hose package is made possible during a relative movement between two articulated arms. Such a guide apparatus in an industrial robot may be found, for example, in European Application EP 2 956 277 A1, corresponding to U.S. Pat. No. 10,059,011 B2.

The high stresses of the protective hose may cause damage to the protective hose, so the protective effect thereof is impaired. If a damaged protective hose is not replaced or repaired in time, that may lead to failure of the cables guided in the protective hose, and failure and a down time may occur. In highly automated manufacturing plants and in an industrial environment, a damaged protective hose frequently cannot be detected in time since there is no accessibility, or only limited accessibility, for example for visual inspection.

The present invention includes a method for monitoring the movement of a protective hose with the aid of a sensor device.

### SUMMARY OF THE INVENTION

It is accordingly an object of the invention to provide a guide apparatus for guiding at least one cable placed in a protective hose, including a sensor device with an ultrasound transmitter, and a retrofit kit and a method for monitoring movement of such a protective hose, which overcome the hereinafore-mentioned disadvantages of the heretofore-known devices and methods of this general type and which make such a sensor device economical and at the same time reliable.

With the foregoing and other objects in view there is provided, in accordance with the invention, a guide apparatus for guiding at least one cable, in particular of an articulated-arm robot, which is placed in a protective hose, having a guide unit, wherein the guide unit has a static support and a fastening element for fastening the protective hose, the fastening element can travel along the support in a longitudinal direction in order to enable a compensating movement of the protective hose and of the at least one cable placed therein, the guide apparatus has a sensor device for measuring the movement of the fastening element relative to the support and the sensor device has a transmitter, configured as an ultrasound transmitter, as a first sensor component for delivering a sensor signal, as well as a second sensor component which lies opposite in the longitudinal direction, with a signal path extending in the longitudinal direction between the two sensor components, and a reflector surface for the sensor signal is disposed laterally next to the signal path so that at least a part of the sensor signal is reflected at the reflector surface on its way from the transmitter to the second sensor component during operation.

With the objects of the invention in view, there is also provided a retrofit kit for forming a guide apparatus according to the invention, wherein the retrofit kit has a sensor device which can be mounted on a guide unit and is configured to measure the movement of a protective hose of the guide unit.

With the objects of the invention in view, there is concomitantly provided a method for monitoring the movement of a protective hose of a guide apparatus that serves to guide at least one cable which is placed in the protective hose, wherein the guide apparatus has a guide unit with a fastening element for fastening the protective hose and with a static support, the fastening element can travel along the support in a longitudinal direction in order to enable a compensating movement of the protective hose and of the at least one cable placed therein, the guide apparatus has a sensor device for measuring the movement of the fastening element relative to the support and the sensor device has a transmitter, configured as an ultrasound transmitter, as a first sensor component for delivering a sensor signal, as well as a second sensor component which lies opposite in the longitudinal direction, with a signal path extending in the longitudinal direction between the two sensor components, and a reflector surface for the sensor signal is disposed laterally next to the signal path so that at least a part of the sensor signal is reflected at the reflector surface on its way from the transmitter to the second sensor component.

The advantages and preferred embodiments mentioned with respect to the guide apparatus may also be applied correspondingly to the retrofit kit and to the method, and vice versa.

The guide apparatus generally serves to guide at least one cable, specifically in particular a cable of a multi-axis articulated-arm robot, especially of a multiaxis industrial robot, which is placed in a protective hose and to which the guide apparatus is fastened during operation. Generally, the guide apparatus is fastened in the mounted state to a processing machine which has at least two mutually mobile machine parts. The at least one cable, preferably a plurality of cables, and the protective hose form a hose package. The cable and the protective hose are not necessarily part of the guide apparatus, although preferentially they are. In the mounted state and during operation, the protective hose is mounted on the guide apparatus and at least then is part of the guide apparatus.

The guide apparatus has a guide unit extending in a longitudinal direction, which includes a fastening element to which the protective hose is fastened during operation. The guide unit furthermore includes a static support, which preferentially is fixed statically on the articulated-arm robot in the mounted state. The guide unit is in particular a compact independent module, which can be mounted as such on a machine, in particular on the articulated-arm robot, for example by using the support. For example, the support is a base plate of a support housing of the guide unit. In principle, it is also possible that the support itself is part of the machine. The guide unit is, for example, a known guide unit such as is described for example in European Application EP 2 956 277 A1, corresponding to U.S. Pat. No. 10,059,011 B2, which was mentioned in the

### INTRODUCTION

During operation, the protective hose fastened to the fastening element can travel along the support, relative to the latter. The fastening element is carried on the support, displaceably along the support in a longitudinal direction. This serves, in particular, to enable a compensating movement of the protective hose and of the at least one cable guided therein during operation.

The guide apparatus furthermore has a sensor device, which is configured to measure the movement of the fastening element relative to the support. Movement data, in particular movement patterns of the protective hose, are preferentially thereby recorded.

The sensor device thus serves in particular, and is configured, to measure the movement of the protective hose at least indirectly during operation when the protective hose is mounted, and therefore to record movement data of the protective hose.

The sensor device has a transmitter, configured as an ultrasound transmitter, as a first sensor component, which is configured to deliver an ultrasound sensor signal. A second sensor component is fitted opposite thereto in the longitudinal direction. During operation, the sensor signal is sent from the transmitter to the second sensor component, and therefore along a signal path extending in the longitudinal direction. The transmitter and the second sensor component are connected at least indirectly on the one hand to the static support and on the other hand to the mobile fastening element so that the transmitter and the second sensor component can perform a relative movement with respect to one another, which corresponds to a relative movement between the fastening element and the support during operation of the articulated-arm robot.

In order to be able to carry out a reliable measurement with a sufficient signal intensity, according to the invention a reflector surface for the sensor signal is disposed laterally next to the signal path. This reflector surface is configured and disposed so that at least a part of the sensor signal is reflected at the reflector surface on its way from the transmitter to the second sensor component during operation.

Preferentially, the second sensor component is a reflector which reflects the sensor signal and sends it back in the direction of the transmitter. Disposed at the location of the transmitter, in this embodiment variant, there is therefore preferentially furthermore a receiver for the (reflected) ultrasound sensor signal. The transmitter and the receiver may, in particular, form a combined module. The reflector is, for example, a plate with a reflective surface, in particular a metal plate or a plate made of a polymer.

As an alternative to this embodiment variant, it is also possible that the second sensor component is configured as the receiver. Nevertheless, the variant with the reflector is preferred.

In a preferred embodiment, the transmitter, and in particular the combined module including the transmitter and the receiver, is connected statically to the support and the reflector is fitted on the mobile fastening element. By this measure, only the passive reflector is mobile and the active components of the sensor device, which in particular are attached via electrical cables, are fitted statically.

This embodiment with the lateral reflector surface is based on the idea that ultrasound transmitters, in particular those with a reasonable price, as a rule have a comparatively large emission angle. This requires a large sensor area on the second sensor component for reliable signal acquisition. In such a guide apparatus, however, particularly on an industrial robot, an arrangement that is as compact and space-saving as possible is important in order to keep interfering contours on the robot as small as possible. This entails the requirement that the sensor device is configured as compactly built as possible, with the result that a sufficient size for this sensor area is not available. Only a small sensor area can therefore be used, so that there is a risk that a part of the sensor signal will not be reflected at the reflector and/or not reach the receiver. This makes reliable evaluation of the ultrasound signal at least difficult. The effect achieved by arranging the reflector surface laterally next to the signal path is that at least a part of the sensor signal is reflected at this reflector surface and the signal component reflected at the reflector, or arriving at the receiver, is increased in comparison to a variant without a reflector surface.

The reflector surface is preferably disposed immediately next to the signal path. In the present case, the signal path is generally defined by a connecting line extending in the longitudinal direction between the transmitter (or more precisely a midpoint of the transmitter) and the second sensor component. The reflector surface is disposed a few centimeters, in particular a few millimeters, away from the signal path and therefore away from such a connecting line; for example, the lateral distance from the connecting line is only at most 5 cm, preferably only at most 1 cm, in particular only at most 8 mm, especially only at most 5 mm. A minimum distance is, for example, 3 mm.

In a preferred embodiment, a nonreflective region is formed opposite the reflector surface, specifically in such a way that a part reflected at the reflector surface is not reflected multiple times. Losses are therefore intentionally tolerated. This is based on the idea that multiple reflections would lead to an impairment of the evaluation of the sensor signal measured at the receiver.

Preferentially, the sensor device is integrated inside a sensor housing, which is disposed next to the support. The sensor housing has an inner side that forms the reflector surface. Because of the sensor housing, the sensor device is better protected overall from environmental influences.

The sensor housing preferentially has at least one opening on the opposite side from the reflector surface, or is completely open there. The opening extends in particular over the entire maximum length between the transmitter and the second sensor component. The opening is dimensioned to be at least sufficiently large to prevent the multiple reflections as described above, or at least to reduce them significantly in comparison to a closed configuration of the sensor housing.

The opening preferentially has an opening width which is at least 10%, more preferentially at least 20% and more preferably at least 50% of the width of the sensor housing (of the housing side on which the opening is formed). According to one embodiment variant, the opening width corresponds to the width of the sensor housing.

The entire sensor housing is preferentially configured in cross section as a rectangle, for example as a square. It has, for example, a width of from 4 cm to 8 cm on the housing side on which the opening is formed.

As an alternative or in addition, the opening has an opening width of at least 15 mm or at least 25 mm.

The second sensor component is preferentially connected to the fastening element of the guide unit via a connecting element, the connecting element being fed through the opening. The opening width is preferably selected to be greater than a thickness of the connecting element, so that a free opening gap is formed between the opening and the connecting element. The opening width is therefore selected to be comparatively large for reasons of the signal routing. The fact that the comparatively wide opening reduces the protection of the interior of the sensor housing from the environment, and therefore from the environmental influences, is intentionally tolerated.

The opening width is in particular a multiple of, for example at least 2 times, or at least 3 times or even at least 5 times a thickness of the connecting element. The opening gap, i.e. the difference between the thickness of the connecting element and the opening width, is preferentially more than 15 mm.

With a view to optimal reflection, a distance of the second sensor component from the reflector surface is selected to be as small as possible, and in particular is only a few mm. Preferentially, the distance is less than 8 mm, in particular less than 5 mm and more preferentially less than 3 mm.

As an alternative or in addition to such an opening, the sensor housing has, at least on the opposite side from the reflector surface, a surface that absorbs the sensor signal. In addition, further wall regions that are adjacent to the inner side with the reflector surface may also be provided with such an absorbent surface. In this embodiment variant, the inner sides of the sensor housing are therefore configured differently. While one inner wall region forms the reflector surface, other inner wall regions form absorption surfaces.

For the formation of the surface that absorbs the sensor signal, the latter or the corresponding wall regions are suitably configured and are provided, for example, with a cladding of a suitable sound-absorbing material, for example a nonwoven or foam.

The reflector surface is preferentially formed by the material of the sensor housing itself. This material is preferably a metal, in particular aluminum. The sensor housing is formed for example by a continuously cast profiled section, which is preferably closed at its opposite frontal end sides.

The support of the guide unit preferably has a support housing, or it can be connected to a support housing. A restoring mechanism is conventionally received inside the support housing and lies protected in the support housing. The sensor device is generally disposed next to the support and therefore also next to the support housing, in particular outside the support housing.

Particularly in an embodiment variant as an alternative to the configuration with the sensor housing, an outer wall of the support housing is configured as the reflector surface. In this variant, the sensor device is therefore not housed in the separate sensor housing separated therefrom, but rather the transmitter and the second sensor component are disposed immediately next to the support housing and at least a subregion of the latter is configured as the reflector surface. Expediently, only a subregion of the support housing is configured as the reflector surface, in particular by a suitable configuration of the surface of the support housing. The other surface regions of the support housing are, for example, configured differently thereto.

The transmitter preferentially has an emission angle for the sensor signal which is greater than or equal to 20° or greater than or equal to 30°, and is preferably at most 50°. In particular, the emission angle lies in the range of between 25° and 35°.

The ultrasound transmitter generally emits the ultrasound signal into a conical region of space (emission cone). An emission angle is to be understood in the present case as an apex angle (aperture angle) of such an emission cone, i.e. the angle that the lateral surface of the emission cone includes with itself.

Preferentially, the distance between the transmitter and the second sensor component is at most 45 cm, preferentially at most 40 cm and more preferentially at most 35 cm. This distance corresponds in particular to the range of travel of the fastening element. The transmitter and the second sensor component are therefore in particular fitted with respect to one another in such a way that the maximum distance between them corresponds to the maximum range of travel, at least substantially (+/−5 cm). This distance varies during operation due to the relative movement between the support and the fastening element.

Furthermore, the second sensor component, and therefore in particular the reflector, has a sensor area which is less than 25 cm², in particular less than 15 cm² and more preferentially less than 10 cm². The sensor area is, in particular, configured as a rectangle. By this small sensor area, a sensor device that is as compactly built as possible is achieved overall. The size of the reflector corresponds in particular to the size of the sensor area, i.e. it is formed in particular by the sensor area.

Overall, reliable measurement and evaluation of the ultrasound sensor signal are achieved by the dimensions described herein.

During operation, the movement sequence of the fastening element relative to the support, and therefore the movement sequence of a protective hose, can therefore be recorded and evaluated reliably.

With the aid of the recorded movement sequence, by suitable evaluation, it is checked whether the protective hose is damaged. As an alternative or in addition, whether there is interference in the movement sequence of the guide unit overall is checked. Especially, in addition or as a further alternative, whether there is a change of a movement pattern of the guide unit is checked, for example due to an altered process setting. The nature of the checking and evaluation is described below.

The retrofit kit according to the invention has such a sensor device, which is configured to be mounted on an (existing) guide unit. Existing plants may therefore also be retrofitted straightforwardly with the retrofit kit.

Especially, the retrofit kit is a module that can be mounted as such on the guide unit and/or on the articulated-arm robot. For this purpose, the module has mounting elements for fastening it. In particular, these are screws, clamps, etc. In a preferred embodiment, the mounting elements are ones that allow fastening without tools. In particular, these are magnets so that the sensor device is fastened to the articulated-arm robot, and especially to the guide unit, in particular only by magnets.

In the embodiment variant with the sensor housing, the retrofit kit in particular also includes the sensor housing with the component parts disposed therein, in particular the sensor and the second sensor component.

The guide unit generally has a restoring mechanism, which is configured for automatic return, in particular actuated by spring force, of the fastening element and therefore of the protective hose into a starting position. The restoring mechanism actuated by spring force exerts in particular a prestress on the protective hose, especially via the fastening element. A deflection of the hose package from the starting position takes place by a forcible movement of the processing machine, especially of the articulated-arm robot, i.e. for example with a positively controlled movement of the robot hand to which the at least one cable is fastened. This return mechanism is, in particular, fastened to the support.

The fastening element furthermore includes a slider element, on which the restoring mechanism exerts the restoring force. The slider element is in particular a carriage which is guided along a guide, in particular a linear guide.

The restoring mechanism is in particular housed in the support housing of the guide unit. This support housing has at least one slot, and preferably two opposite lateral longitudinal slots. Because of the at least one slot, the internally lying slider element is connected to a fastening bracket for fastening the protective hose. The slider element and the fastening bracket form the fastening element, or at least part of the fastening element. Preferentially, the fastening element generally has such a fastening bracket for clamped fastening of the protective hose.

The fastening element has in particular a stirrup which engages around the support housing, especially a support housing cover, and the peripheral stirrup arms of which engage through the two aforementioned lateral longitudinal slots into the interior of the support, where they are connected to the restoring mechanism, especially to the slider element.

The mobile sensor component is preferentially connected firmly to this stirrup.

Other features which are considered as characteristic for the invention are set forth in the appended claims.

Although the invention is illustrated and described herein as embodied in a guide apparatus for guiding at least one cable placed in a protective hose, including a sensor device with an ultrasound transmitter, and a retrofit kit and a method for monitoring movement of such a protective hose, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a simplified, diagrammatic, side-elevational view of an industrial robot with a guide apparatus;

FIG. 2 is a perspective view of a guide apparatus without a hose package, with a first sensor device and with a reflector surface on the support housing;

FIG. 3 is a plan view of the guide apparatus according to FIG. 2, but with a further sensor device with a sensor housing; and

FIG. 4 is a sectional view through the sensor housing, which is taken along the section line IV-IV in FIG. 3, in the direction of the arrows.

### DETAILED DESCRIPTION OF THE INVENTION

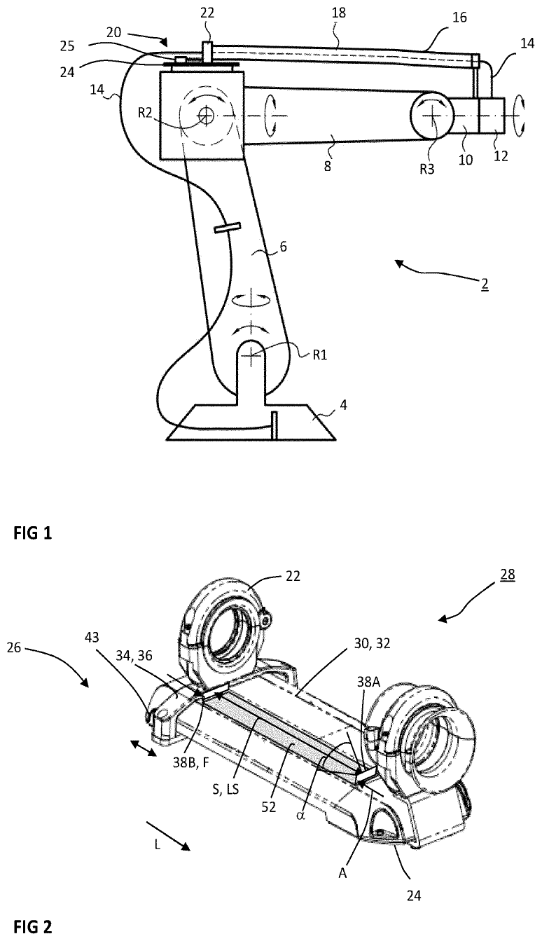

Referring now to the figures of the drawings in detail and first, particularly, to FIG. 1 thereof, there is seen an articulated-arm robot 2 as a processing machine, particularly in an embodiment variant as a multi-axis, in particular six-axis industrial robot. The latter generally has a base 4 and a first segment, referred to as a rocker arm 6, which is connected to the base 4 via a first articulated connection R1. The rocker arm 6 can be pivoted about a horizontal axis about this first articulated connection R1. In addition, the rocker arm 6 can conventionally be pivoted relative to the base 4 about a vertical axis. The rocker arm 6 extends upward approximately in the vertical direction. A second segment, generally referred to as a robot arm 8, is connected pivotably at a second articulated connection R2 about a so-called “axis 3” to the rocker arm 6. Furthermore, as a third segment, a robot hand 10 is connected to the robot arm 8 via a third articulated connection R3. Lastly, a processing tool 12, for example a welding gun, etc., is fitted on the robot hand 10. Such an industrial robot typically has more than four or more than five, for example six, different movement degrees of freedom.

In order to supply the processing tool 12 with electricity and/or fluids and/or data signals, the articulated-arm robot 2 has a supply cable package, which is guided along the robot arm 2 and from there is connected, for example, to the base 4. The supply cable package has at least one cable 14, and preferably a plurality of cables 14, which are guided at least in the region of the robot arm 8 in a protective hose 16. The cables 14 together with the protective hose 16 are referred to below as a hose package 18. Frequently, a separating point for the supply cable package is disposed in the region of the second articulated connection R2 and the hose package 18 is guided as far as this separating point as a replaceable wearing unit.

In order to guide the hose package and particularly in order to execute a return movement, a guide apparatus 20 is fastened in the region of the second articulated connection R2 to the robot arm 2. Associated with this guide apparatus 20 is a fastening bracket 22 in which the hose package 18 is retained, in particular with a form-locking connection, so that a restoring force exerted on the guide apparatus 20 is transmitted to the hose package 18.

The guide apparatus 20 has a support 24, by which it is fastened to the articulated-arm robot 2, particularly in the region of the second articulated connection R2. During a movement of the hose package 18, the latter and with it the fastening bracket 22 execute an in particular linear relative movement with respect to the support 24. A restoring mechanism 25, which is fitted on the support, exerts a resilient restoring force on the fastening bracket 22. For this purpose, the fastening bracket 22 is in particular connected to a slider element (not represented in detail) which is fastened linearly displaceably to the support 24.

The guide apparatus 20 is now equipped with a sensor device 26 for prompt detection of damage to the protective hose 16, as will be explained in more detail below with the aid of FIG. 2 to FIG. 4.

The illustrated guide apparatus 20 firstly has a guide unit 28. The latter includes a support housing 30, which on the bottom side has the support 24 on which a housing cover 32 is fitted. A restoring mechanism (not represented in detail here), which is formed in a free inner space, has a resilient restoring element, in particular a spring element, that exerts a resilient restoring force on a slider element (not visible). The guide unit 28 has a fastening element 34, which is connected to the slider element and is linearly displaceable along the support 24. In the exemplary embodiment, this fastening element 34 includes a stirrup 36, which engages around the housing cover 32 and engages through lateral longitudinal slots into the interior, where it is connected to the slider element. The aforementioned fastening bracket 22, in which the protective hose 16 is fixed in the mounted state, is fastened to the stirrup 36. In the exemplary embodiment, the guide unit 28 also has a slideway at its front end, which is connected statically to the support 24 and by which the hose package 18 is guided in sliding displacement.

During operation, the protective hose 16 and with it the fastening bracket 22, as well as the entire fastening element 34, therefore travel linearly back and forth along the guide unit 28 in order to enable the compensating movement. The articulated-arm robot 2 is conventionally programmed for periodically recurrent working sequences, for example in order to carry out a plurality of individual welding actions on a component within a working cycle. The same working cycle takes place again for the next component. Within such a working cycle, the protective hose 16 and therefore the fastening element 34 accomplish a defined movement pattern. With the aid of the movement pattern, it is possible to detect whether the guide apparatus 20 and/or the articulated-arm robot 20 is carrying out a correct movement sequence according to a setpoint specification.

Through the use of the sensor device 26 represented in FIGS. 2-4, the movement sequence of the hose package 18, in particular the relative movement of the protective hose 16 with respect to the support 24, is measured and the movement data which are thereby recorded are evaluated.

For this purpose, the (linear) movement of the fastening element 34, in particular of the stirrup 36, relative to the support 24 is recorded and evaluated.

The sensor device 26 has a static first sensor component which is formed by, or has, an ultrasound transmitter 38A. The sensor device 26 furthermore has a mobile second sensor component, which is formed in the exemplary embodiment by a reflector 38B. The latter is fastened to the fastening element 34, while the transmitter 38A is fastened to the support 24. Through the use of the sensor device 26, the relative movement of the mobile sensor component with respect to the static sensor component is measured.

During operation, an ultrasound sensor signal S emitted by the transmitter 38A is reflected at the reflector 38B and sent back in the direction of the first sensor component, which is configured in particular as a combined transmitter and receiver unit and therefore in addition also has an ultrasound receiver. The received ultrasound sensor signal S is suitably evaluated.

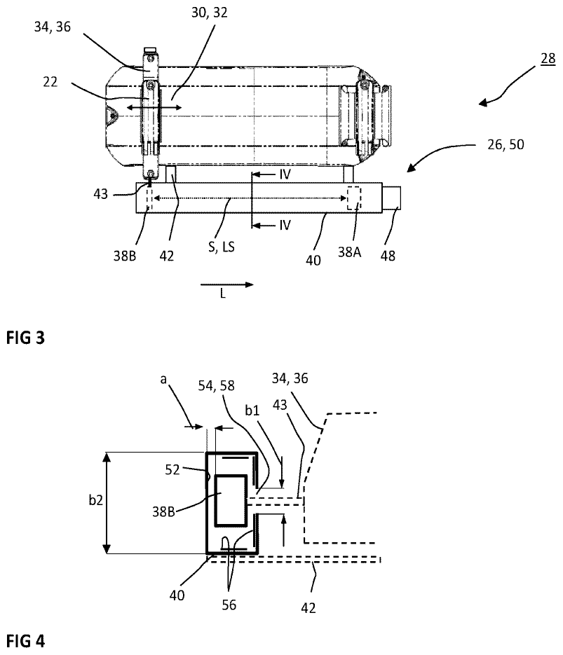

The current position of the mobile sensor component 38B is, for example, evaluated by calculating the time of flight of the sensor signal S. This takes place in particular with the aid of an evaluation unit 48, which is represented by way of example in FIG. 3. It is, in particular, fitted in the region of the transmitter 38A and for example forms a combined electronic module therewith. As an alternative thereto, it is also possible that the received sensor signals S are forwarded to a superordinate evaluation unit.

The transmitter 38A and the reflector 38B are disposed opposite one another in a longitudinal direction L. A connecting line between these components in this regard forms a linear signal path LS.

The transmitter 38A emits the ultrasound sensor signal S with an emission angle α, which is for example 30°.

For reasons of installation space, the reflector 38B is kept small and has a sensor area F that is preferentially at most 10 cm². For example, the reflector 38B has a sensor area F of 4 cm×2 cm. The dimensions of the sensor area F are in particular identical to the dimensions of the reflector 38B, which is preferentially configured as a metal plate or as a plate made of a polymer.

FIG. 2 shows a state in which the fastening element 34, and therefore the fastening bracket 22, are in a maximally deployed state. Correspondingly, the transmitter 38A and the reflector 38B in this state have a maximum distance A from one another, which is preferably at most 40 cm.

The reflector 38B generally is preferably disposed directly at the height of the fastening element 34. The transmitter 38A is fitted at the opposite end region of the support 24.

Because of the large emission angle α and the only small reflector area F, there is a risk that a fraction of the sensor signal S will not be reflected, or will not reach the receiver, and the evaluation will therefore be made difficult.

In order to increase the reliability of the measurement, a reflector surface 52 is now provided, which is fitted next to the signal path LS. By this reflector surface 52, at least a part of the sensor signal S is again reflected and therefore strikes the reflector 38B, and can be sent back.

In the exemplary embodiment of FIG. 2, the reflector surface 52 is formed by a subregion of the outer wall of the support housing 30, especially of the housing cover 32, as is represented by the gray colored area. Preferentially, the reflector surface 52 is disposed on the upper side of the housing cover 32 and therefore below the hose package 18. The reflector surface 52 is in particular a special surface coating or a surface material that is suitable for reflecting ultrasound signals. The reflector surface 52 is preferably different from the rest of the outer surface regions of the support housing 30. The reflector 38B is, for example, fitted in particular directly on the stirrup 36 or on the fastening bracket 22. The transmitter 38A is, for example, fastened to the housing cover 32. The fastening of the reflector 38B and/or of the transmitter 38A takes place for example with a form-locking or force-locking connection, or preferentially materially, for example by adhesive bonding or welding.

According to FIG. 3, the sensor device 26 includes a sensor housing 40 which is disposed next to the guide unit 28 and, in particular, is fastened to the latter. The transmitter 38A and the reflector 38B are disposed inside the sensor housing 40. The sensor housing 40 and in particular the entire sensor device 26 is fastened to the guide unit 28 by mounting elements 42. In one alternative exemplary embodiment, fastening to a component of the articulated-arm robot 2, for example on the robot arm 8, is also possible.

The mobile sensor component 38B disposed in the sensor housing 40 is connected via a connecting element 43, which protrudes from the sensor housing 40, to the fastening element 34, and especially is connected to the stirrup 36. The connecting element 43 therefore executes a relative movement with respect to the sensor housing 40 during operation. For this purpose, the latter has an opening slot preferentially running in the longitudinal direction L, along which the connecting element 43 can travel.

As may be seen in particular with the aid of FIG. 4, the sensor housing 40 has an inner side that forms the reflector surface 52. The latter is, for example, a special surface treatment or surface coating. In the exemplary embodiment, the reflector surface 52 is formed directly by the side wall of the sensor housing 40. The latter is in particular a metal housing, in particular made of aluminum.

The side wall with the reflector surface 52 is preferentially different from the rest of the inner surface regions of the sensor housing 40.

It should be pointed out that, as may be seen in FIG. 4, the sensor housing 40 is open opposite the reflector surface 52, i.e. it has an opening 54 which extends in the longitudinal direction L and, in particular, extends over the entire maximum distance A. The opening 54 has an opening width b1 which is preferably at least 10% and at least 20%, and preferably at least 50% of the width b2 of the sensor housing 40.

Preferentially, the opening width b1 is at least greater than 15 mm or at least greater than 25 mm.

In addition or as an alternative, it is also possible that inner surface regions adjacent and/or opposite to the reflector surface 52 have an absorbent surface 56. This is preferentially achieved by applying a suitable coating or a suitable material, for example a nonwoven, so that the corresponding subregions are thus so to speak clad with an ultrasound-absorbing material.

In the exemplary embodiment, the sensor housing 40 has a rectangular cross section. Preferentially, the reflector surface 52 is a long side of the rectangular sensor housing 40 and/or the reflector 38B is likewise configured as a rectangle and its long side is disposed opposite the reflector surface 52, which has a positive effect on the signal reflection.

FIG. 4 partially indicates the mounting element 42, the fastening element 34, or the stirrup 36, and the connecting element 43 by dashes. It may also be seen clearly that the connecting element 43 engages through the above-described opening 54 and is fed to the reflector 38B, which it holds.

It should be mentioned that an opening gap 58 is formed between the connecting element 43 and the opening 54, or more precisely an opening edge. Overall, the opening width b1 is preferentially a multiple of a thickness of the connecting element 43, so that a sufficiently large opening gap 58 is formed in order to achieve the desired effects for the signal propagation. The opening gap 58, i.e. the difference between the thickness of the connecting element 43 and the opening width b1, is in particular more than 15 mm, preferentially more than 20 mm or more than 30 mm. The housing width b2 preferably lies in the range of between 4 cm and 8 cm.

With a view to reflection at the reflection surface 52, a distance a between the reflector 38B and the reflector surface 52 is selected to be as small as possible. Preferentially, this distance a lies only in the range of a few mm and is in particular less than 8 mm, preferably less than 5 mm and in particular less than 3 mm. The minimum distance corresponds to a tolerance gap between the reflector and the inner wall, which is required for the ability to travel. Preferentially, the distance a corresponds to such a minimum tolerance gap.

The sensor device 26 is configured in particular to also be retrofitted on existing guide units 28. For this purpose, a retrofit kit 50 that can be mounted retrospectively on an existing guide unit 28 is provided overall. This retrofit kit 50 has in particular the two sensor components 38A, 38B, preferably the evaluation unit 48 and/or at least a communication unit for transmitting data signals to a remote evaluation unit. The mounting elements 42 are preferably furthermore associated with the retrofit kit 50. In the embodiment variant with the sensor housing 40, the latter is a part of the retrofit kit. Preferentially, the retrofit kit 50 has a combined mounting module formed from these elements, or is such a mounting module. The latter is formed in particular of the sensor housing 40 and the mounting elements 42, the sensor components 38A, 38B already being contained preassembled inside the sensor housing 40. The evaluation unit 48 is in one variant likewise part of this mounting module. In this case, only the mounting on the guide unit 28 still remains necessary.

The following is a summary list of reference numerals and the corresponding structure used in the above description of the invention:
2 articulated-arm robot
4 base
6 rocker arm
8 robot arm
10 robot hand
12 processing tool
14 cable
16 protective hose
18 hose package
20 guide apparatus
22 fastening bracket
24 support
25 restoring mechanism
26 sensor device
28 guide unit
30 support housing
32 housing cover
34 fastening element
36 stirrup
38A sensor
38B reflector
40 sensor housing
42 mounting element
43 connecting element
48 evaluation unit
50 retrofit kit
52 reflector surface
54 opening
56 absorbent surface
58 opening gap
L longitudinal direction
LS linear signal path
α emission angle
F sensor area
b1 opening width
b2 width of the sensor housing
R1 1st articulated connection
R2 2nd articulated connection
R3 3rd articulated connection
S sensor signal
A distance
a distance between reflector surface and reflector

1. A guide apparatus for guiding at least one cable or at least one cable of an articulated-arm robot disposed in a protective hose, the guide apparatus comprising:
a guide unit having a static support and a fastening element for fastening the protective hose;
said fastening element configured to travel along said support in a longitudinal direction for enabling a compensating movement of the protective hose and of the at least one cable disposed in the protective hose;
a sensor device for measuring a movement of said fastening element relative to said static support, said sensor device having a transmitter configured as an ultrasound transmitter acting as a first sensor component for delivering a sensor signal, and said sensor device having a second sensor component lying opposite said first sensor component in the longitudinal direction, defining a signal path extending in the longitudinal direction between said first and second sensor components; and
a reflector surface disposed laterally next to the signal path for reflecting the sensor signal, said reflector surface reflecting at least a part of the sensor signal at said reflector surface along the signal path from said transmitter acting as said first sensor component to said second sensor component during operation.

2. The guide apparatus according to claim 1, wherein said transmitter is connected to said static support, and said second sensor component is configured as a reflector for the sensor signal and is connected to said fastening element.

3. The guide apparatus according to claim 1, which further comprises a nonreflective region formed opposite said reflector surface for preventing a part of the sensor signal reflected at said reflector surface from being reflected multiple times.

4. The guide apparatus according to claim 1, which further comprises a sensor housing disposed next to said static support, said sensor housing having an inner side forming said reflector surface, and said sensor device being integrated inside said sensor housing.

5. The guide apparatus according to claim 4, wherein said sensor housing has at least one opening, or is completely open, on a side opposite said reflector surface.

6. The guide apparatus according to claim 5, wherein said opening has an opening width being at least one of:
at least 10% of a width of said sensor housing, or
at least 15 mm.

7. The guide apparatus according to claim 5, which further comprises:
a connecting element connecting said second sensor component to said fastening element, said connecting element being fed through said opening and having a thickness;
said opening having an opening width being greater than said thickness of said connecting element, forming a free opening gap between said opening and said connecting element.

8. The guide apparatus according to claim 7, wherein at least one of said opening width corresponds to a multiple of said thickness of said connecting element, or said opening gap is more than 15 mm.

9. The guide apparatus according to claim 4, wherein said second sensor component and said reflector surface are mutually spaced apart by a distance of less than 8 mm.

10. The guide apparatus according to claim 4, wherein said second sensor component and said reflector surface are mutually spaced apart by a distance of less than 5 mm.

11. The guide apparatus according to claim 4, wherein said second sensor component and said reflector surface are mutually spaced apart by a distance of less than 3 mm.

12. The guide apparatus according to claim 4, wherein said sensor housing has a surface at least at a side opposite said reflector surface, said opposite surface absorbing the sensor signal.

13. The guide apparatus according to claim 1, which further comprises a support housing, said static support having said support housing or said static support configured to be connected to said support housing, said sensor device being disposed next to said support housing, and said support housing including an outer wall having said reflector surface.

14. The guide apparatus according to claim 1, wherein said transmitter has an emission angle for the sensor signal being greater than or equal to 20°.

15. The guide apparatus according to claim 1, wherein said transmitter has an emission angle for the sensor signal lying in a range of between 25° and 35°.

16. The guide apparatus according to claim 1, wherein said transmitter and said second sensor component are mutually spaced apart by a distance of at most 45 cm.

17. The guide apparatus according to claim 1, wherein said second sensor component has a sensor area being less than 25 cm².

18. The guide apparatus according to claim 1, which further comprises an evaluation unit for evaluating movement data recorded during a measurement with respect to at least one of:
a. damage to the protective hose, or
b. interference in a movement sequence of said guide unit, or
c. a change of a movement pattern of said guide unit.

19. A retrofit kit for forming the guide apparatus according to claim 1, the retrofit kit comprising said sensor device configured to be mounted on said guide unit and configured to measure a movement of the protective hose at said guide unit.

20. A method for monitoring a movement of a protective hose of a guide apparatus serving to guide at least one cable placed in the protective hose, the method comprising:
providing a guide apparatus, the guide apparatus having a guide unit with a fastening element for fastening the protective hose and a static support, the fastening element configured to travel along the static support in a longitudinal direction for enabling a compensating movement of the protective hose and of the at least one cable disposed in the protective hose, the guide apparatus having a sensor device for measuring a movement of the fastening element relative to the static support, the sensor device having a transmitter configured as an ultrasound transmitter and acting as a first sensor component for delivering a sensor signal, and the sensor device having a second sensor component lying opposite the first sensor component in the longitudinal direction, defining a signal path extending in the longitudinal direction between the first and second sensor components; and
placing a reflector surface for the sensor signal laterally next to the signal path and reflecting at least a part of the sensor signal at the reflector surface along the signal path from said transmitter acting as said first sensor component to said second sensor component.
